(19) United States
(12) Patent Application Publication
(10) Pub. No.: US 2006/0291380 A1
(43) Pub. Date: Dec. 28, 2006

(54) NUT table automatic updating system coupled with RPR establishment

(75) Inventors: Kumiko Uematsu, Kawasaki (JP); Katsuyuki Tada, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/268,750

(22) Filed: Nov. 8, 2005

(30) Foreign Application Priority Data
Jun. 28, 2005 (JP) 2005-188104

(51) Int. Cl. H04J 1/16

(52) U.S. Cl. 370/222

(57) ABSTRACT

A device, to which an RPR setting instruction is input by a network administrator, comprises an RPR controller and information (RPR information) that the RPR should be set is transmitted to all devices in the established network. In a SONET device at the gateway to a path where the RPR network uses the SONET ring, a NUT controller is comprised. The NUT controller, which received the RPR information, notifies all devices in the SONET ring of information instructing the NUT setting. All of the devices in the SONET ring, which receive the information, perform the NUT setting automatically.

### BACKGROUND OF THE INVENTION

1. Field of the Invention

The present invention relates to a NUT table automatic update system established by using a SONET (Synchronous Optical Network) or an SDH (Synchronous Digital Hierarchy), which is a synchronous network.

2. Description of the Related Art

As backbone transmission networks become increasingly IP-based, application of an RPR (Resilient Packet Ring) to the SONET/SDH networks is sought. RPR provides protection at the point of failure by rerouting using an Ethernet (trademark) MAC address. When RPR is applied to a BLSR (Bidirectional Line Switched Ring) network, there is a risk that signal flapping, caused by sudden discontinuance of tens of ms duration when switching the BLSR in the case of failure, prevents protection operation in the high-order layer, i.e. rerouting of the RPR. In the following description, SONET is explained as an example of a synchronous network; however, SONET can be replaced by SDH, which is equivalent to SONET as a synchronous network.

FIG. 1 is a diagram explaining problems in the conventional art.

In FIG. 1, a BLSR network 10 and an IP network 12 was established in advance. An RPR network 11 is built between routers 13-1 and 13-2 of the RPR network via SONET devices 14-1 and 14-2. The RPR network uses a transmission line between SONET devices 14-1 and 14-2 of the BLSR network 10.

Suppose the line is disconnected between the SONET devices 14-1 and 14-2 at this moment, after tens of ms, the BLSR network 10 sets up a communication line between the SONET devices 14-1 and 14-2 as a detour by its line recovery function and recovers signals transmitted in the disconnected line.

An RPR network 11 also tries to set up a detour after tens of ms, by its recovery function. Then, for example, when setting of a detour by the RPR network 11 in response to the line disconnection is about to be completed, signals are recovered by the BLSR network 10. The RPR network 11 starts to perform processing to undo the setting of the detour in response to the signal recovery. In this manner, when the BLSR network 10 recovers a signal (a communication route) used in the RPR network 11, the detour setting operation of the RPR network 11 is performed twice in succession. Such a repetition of the communication route setting operation is not desired because, for example, a sudden discontinuance of communication occurs and rewriting of a packet route selection table in the RPR network 11 is performed each time.

In order to control the repetition, an optional function of the BLSR is required so that a switch function in the BLSR network does not work in a channel of the BLSR network which supports RPR. This function is requested as a NUT function.

NUT is an abbreviation for Non-preemptible Unprotected Traffic. It is specified by an ANSI T1 standard [NUT] as well as the BLSR, and is defined as “traffic without bandwidth protection, which is not intercepted albeit a failure having occurred”.

A regular protection channel is intercepted for the use of work signal recovery when a failure occurs; however, on the contrary, the NUT channel has a feature, which is not intercepted (without redundancy) even when failure occurs. In other words, as long as there is no failure in a BLSR node and the transmission path that the channel (path) passes through, the NUT channel enables communication using the path. This means that even if a failure occurs in a node or a transmission path, which the path does not go through, the path is not used for the work signal recovery and communication can be continued. When a failure occurs in a node or a transmission path, which the path goes through, recovery of the BLSR is not applied, but. the communication is basically disconnected.

The NUT function enables a user to set up channels with the following priorities (failure resistance levels). In order of highest priority, they are:
1. Protected Channel (protection in the case of a failure is assured)
2. NUT Channel (protection in the case of failure is not assured, but interception does not occur for the recovery of the other channels)
3. Non-protected Channel (protection is not assured, and the interception for recovery occurs in the case of failure. Also known as extra traffic or PCA (Protection Channel Access))

The above problems in FIG. 15 can be explained as follows. In FIG. 15, a configuration is such that a ring of the RPR is established on a part of the BLSR network 10, and performs Ethernet (trademark) communication between A and B. Normally a route (1) is used for communication. The above protected channel is set to the line between the SONET device 14-1 and the SONET device 14-2, which provide the communication.

When a failure occurs between the SONET device 14-1 and the SONET device 14-2, the router 13-1 tries to reroute via another route, that is a route via an IP network 12((2)) in accordance with the recovery function in the RPR; however, the line (1) is restored (recovered) after tens of ms by the switching function in the BLSR network 10. This causes the rerouting determination of the router 13-1 to become unstable, and the communication between A and B flaps.

The NUT setting is managed by a table called a NUT table. An example of NUT table setting is shown in FIG. 2 and FIG. 3.

Suppose that communication is established in the following manner using an OC-192 4-fiber BLSR network in FIG. 2:
(1) An STS1 signal is added to/dropped from a channel 1 of a working line and a signal is transmitted between nodes B and C. In other words, a path described as (1) in FIG. 2 is established.
(2) An STS1 signal is added to/dropped from a channel 1 of a protect line and a signal is transmitted between nodes B and C. In other words, a path described in (2) in FIG. 2 is established.
(3) An STS1 signal is added to/dropped from a channel 1 of a working line and a signal is transmitted between nodes F and D. In other words, a path described in (3) in FIG. 2 is established.

At this point in time, the NUT setting does not exist anywhere in the ring. (Table 1 in FIG. 3) Here, suppose the following is to be set up.
(4) The channel 1 between B and C is to be used as the RPR. Then, in order to disable the switching operation as the BLSR, which is in the low-order layer, the protection channel 1 is set as the NUT channel.

By so doing, the NUT table relating to the nodes B and C is updated as indicated in Table 2 in FIG. 3, and additionally, the other nodes in the ring are updated as indicated in Table 3 in FIG. 3.

In other words, in Table 1 in FIG. 3, settings are established so that the ring switch is in non-use for the nodes B and C, a span switch in the west direction is in non-use for the node B, and a span switch in the east direction is in non-use for the node C. For the other nodes, the ring switches are in non-use. In FIG. 3, an N, representing the NUT setting, indicates that the switch is not used. Therefore, by the NUT setting, the BLSR network is set so as not to perform any unnecessary operations on the line used for the RPR network.

In this context, the ring switch (ring SW) in the BLSR switches paths to form a detour in the whole ring, when a failure such that a path is disconnected occurs, in order to detour the failure site. In the NUT table, the node, in which the ring switch is set to the NUT setting, does not perform switching of the applicable path in the case of failure.

The span switch (span SW) switches from the currently used path, with only a span where failure occurs, to an auxiliary path. In the NUT table, the nodes, of which the span switch is set to the NUT setting, do not perform switching of the applicable channel but do perform switching of the inapplicable channel in a case of failure.

Examples of the NUT function and the NUT table are standardized in the following, and are described in Non-patent Document 1. The BLSR function is also described in Non-patent Document 1. For the RPR network, the standard draft is in Non-patent Document 2.

Non-patent Document 1: ANSI T1. 105.01-2000 “for Telecommunications—Synchronous Optical Network (SONET)—Automatic Protection Switching”

Non-patent Document 2: IEEE Draft P802.17/D3.3 Apr. 21, 2004 “Information technology—Telecommunications and information exchange between systems—Local and metropolitan area networks—Specific requirements—Part 17: Resilient packet ring (RPR) access method & physical layer specifications”

Along with the increasing size and complexity of networks, their management becomes complex, and for that reason, customers (telecommunications carriers) have requested “that the management be as simple as possible”.

For example, when performing intercommunication between a and b in FIG. 4 using an RPR network, an RPR network administrator A carries out setting of a communication route (path) connection to a node J and a node E as the RPR network (however, does not carry out the setting to the other nodes).

An administrator B belongs to a different organization (company) from that of the administrator A, and administers a BLSR network. In this case, a part of the contents of an STS path (that is payloads, hereinafter described as SPE) carries RPR packets in a node D and a node A, and therefore, it is necessary to consider the STS path as a NUT in the BLSR.

However, the object of administration by the administrator B is the STS path at best, and the contents of the SPE are not monitored. The administrator B, therefore, does not have any way of knowing which path is the RPR carrier path. Only the administrator A and the nodes J and E, which are the end points of the RPR packet, know the path. In order to operate a service of the RPR line (path) properly, the administrator A notifies the administrator B of the RPR path information and requests updating the NUT table of the nodes (the Node D and the Node A) and that of the nodes constituting the BLSR (the Node B and the Node C) in which the RPR path is relayed.

However, applying this procedure to a number of paths for every change in the RPR setting increases the operation load of both administrators and the chance of a setting error.

### SUMMARY OF THE INVENTION

The aim of the present invention is to provide a system, which eliminates the above burden and updates the NUT setting on a BLSR promptly, accurately and easily, coupled with the establishment of an RPR path when an RPR is established using a part of the BLSR network.

The NUT table automatic update system of one preferred mode of the present invention is a NUT table automatic update system establishing an RPR network using a path, which is a part of a SONET/SDH ring, comprising RPR control means for receiving an instruction of a setting of the RPR network, and for transmitting RPR information indicating that the RPR network is set in a network device comprised in the RPR network, and NUT control means for, by receiving the RPR information, automatically transmitting NUT information that a NUT table, which applies to the RPR network setting, should be updated on another network device, which belongs to a SONET/SDH ring, to which the network device belongs.

The network device of one preferred mode of the present invention is a network device, which belongs to any network in establishing an RPR network using part of a path in a SONET/SDH ring, comprising RPR control means for receiving an instruction of a setting of the RPR network, and for transmitting RPR information that the RPR network is set in a network device comprised in the RPR network, and NUT control means for, by receiving the RPR information, automatically transmitting NUT information that a NUT table, which applies to the RPR network setting, should be updated on another network device, which belongs to a SONET/SDH ring, to which the network device belongs.

According to the present invention, when an RPR path connection is set and executed, all nodes in the BLSR network going through the path detect the connection, autonomously control the NUT table update of the related channels among nodes and the NUT tables of all nodes are updated appropriately without any manual effort of an administrator. By so doing, an RPR network administrator does not have to notify a BLSR network administrator of the change for every RPR path setting or every path connection. It is not necessary for the BLSR network administrator to execute a NUT table update every time the RPR path connection is changed. Update of the NUT table is realized without requiring a Network Management System (NMS); therefore the system is enabled to comprise a high degree of freedom to changes of the management form.

### BRIEF DESCRIPTION OF THE DRAWINGS

FIG. 1 is a diagram explaining problems in the conventional art;

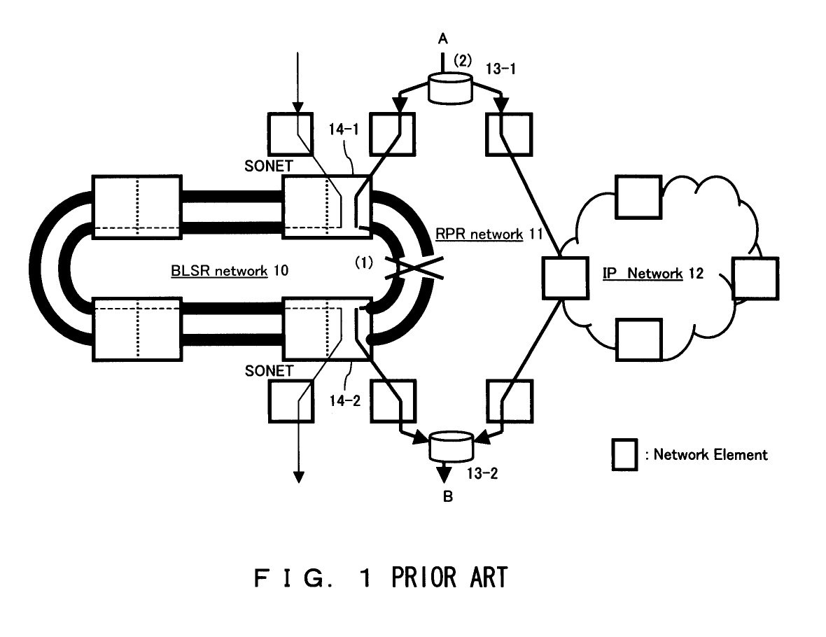

FIG. 2 is a diagram explaining an example of the NUT table setting (1);

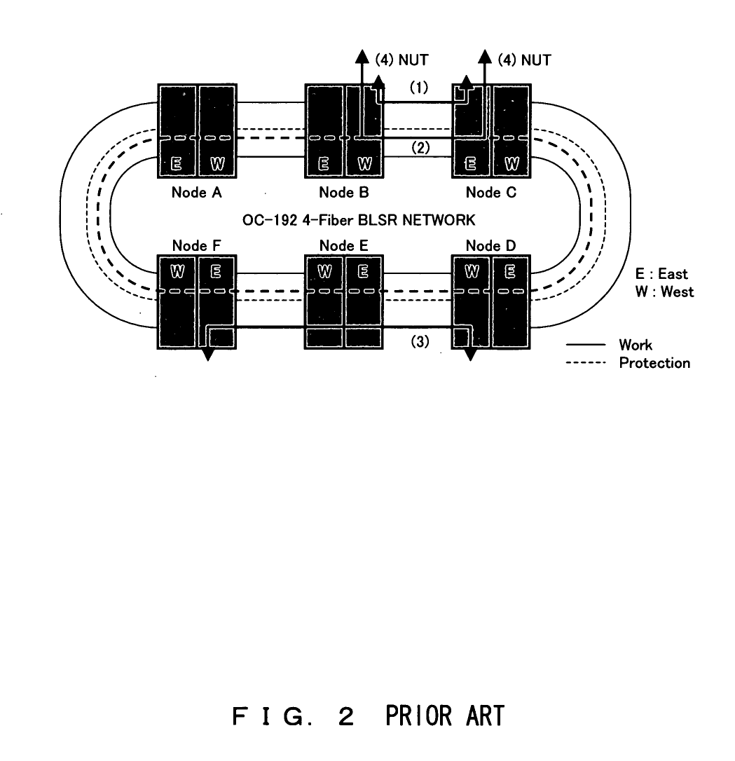

FIG. 3 is a diagram explaining an example of the NUT table setting (2);

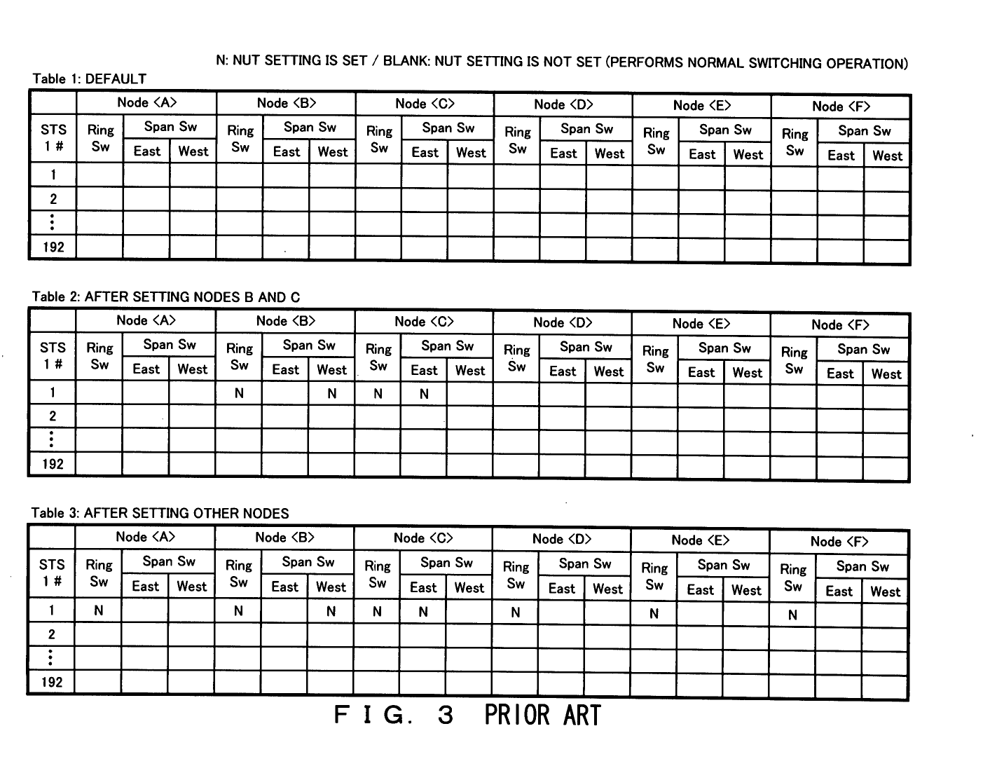

FIG. 4 is a diagram explaining a setting of the RPR connection;

FIG. 5 is an explanatory diagram of RPR information transmission means;

FIG. 6 is a diagram explaining NUT information transmission means;

FIG. 7 is a diagram explaining the operation of an RPR controller of a node, which received an instruction to establish or release the RPR path;

FIG. 8 is a diagram explaining NUT controller processing of the SONET device of a node, which received an instruction to establish or release the RPR path;

FIG. 9 is a state transition table (1) showing an operation of the NUT controller;

FIG. 10 is a state transition table (2) showing an operation of the NUT controller;

FIG. 11 is a processing sequence (1) when the NUT table is established for each device;

FIG. 12 is a processing sequence (2) when the NUT table is established for each device;

FIG. 13 is a diagram showing an example of a value of the SOH in processing in FIG. 11 and FIG. 12;

FIG. 14 is a diagram showing an updated value of the NUT table set by the operations in FIG. 11 through FIG. 13;

FIG. 15 is a processing sequence (1) when the NUT table is established at two sites in parallel;

FIG. 16 is a processing sequence (2) when the NUT table is established at two sites in parallel;

FIG. 17 is a diagram showing an example of the values of the SOH appearing in the sequences in FIG. 15 and FIG. 16; and

FIG. 18 is a diagram showing the NUT table update value in the cases of FIG. 15 through FIG. 17.

### DESCRIPTION OF THE PREFERRED EMBODIMENTS

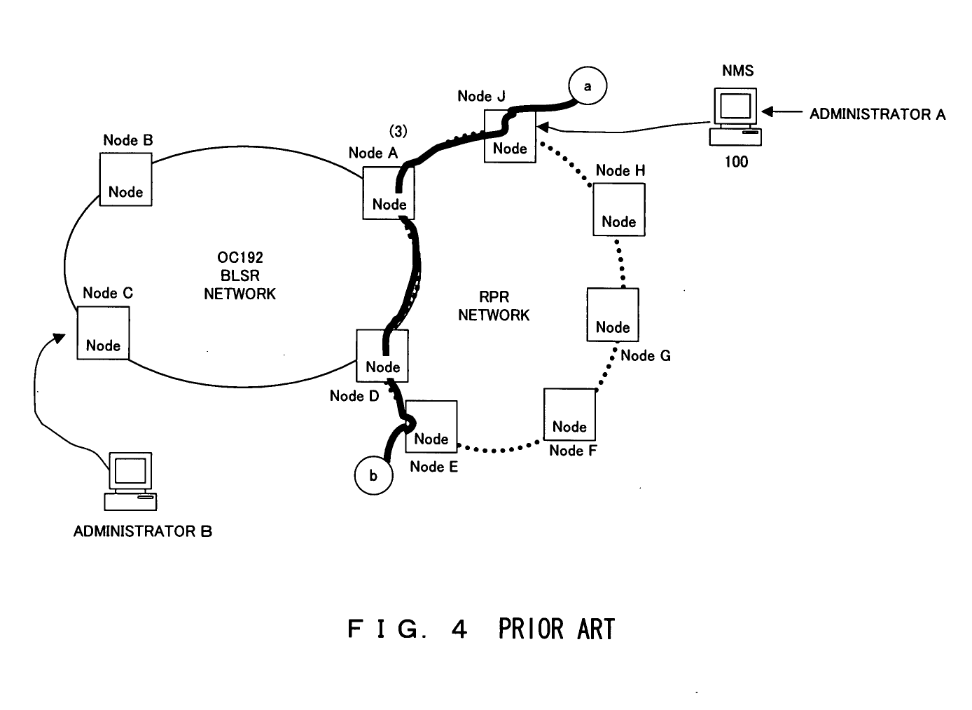

An explanation is provided with reference to FIG. 4.

In FIG. 4, a Node J, a Node A, a Node D, a Node E, a Node F, a Node G, and a Node H constitute an RPR network, which is a ring packet network. To the Node J and the Node E, a terminal a and a terminal b are connected, respectively. An NMS 100, administering each node and a communication path etc. constituting the RPR network, is also connected.

The Node A, the Node B, the Node C and the Node D constitute a BLSR network, which is a synchronous ring network. An NMS 200, administering each node and a communication path etc. constituting the BLSR network, is also connected. Here, the direction to the Node B from the Node A is east, and the direction to the Node D from the Node A is west.

In this example, the Node A and the Node D are the nodes constituting both the BLSR network as the low-order layer and the RPR network as the high-order layer.

In one example of the conventional art, the administrator A sets up a connection between the Node J and the Node E so as to “use the STS channel 5” using the NMS 100 in order to establish an RPR path between a and b. Then, the administrator A notifies the administrator B of a separately administered BLSR network that the relevant path of the BLSR network as the NUT channel for the STS channel 5, going through the Node A and the Node D of the BLSR network, is connected to the RPR line. The administrator B receives the notification, and, using the NMS 200, sets all nodes of the Nodes A, B, C and D to update the NUT table in the way described as follows.
(1) For the STS channel 5 of the Node A, the ring SW is set to the NUT setting (switching disabled), the span SW (east) is not set to the NUT setting, and the span SW (west) is set to the NUT setting
(2) For the STS channel 5 of the Node D, the ring SW is set to the NUT setting, the span SW (east) is set to the NUT setting, and the span SW (west) is not set to NUT setting
(3) For the STS channel 5 of the other nodes, the ring SW is set to the NUT setting, and the span SW (east) and the span SW (west) are not set to the NUT setting

For the STS channel used as an RPR, by prohibiting the ring SW in the entire BLSR network and by prohibiting the span SW in the section that an RPR path goes through, the setting causes the RPR path section to operate as a NUT channel.

In the present invention, the following is added to the SONET device.
RPR controller
NUT controller
   The RPR controller comprises the following functions:
updating a J1 byte in a POH (Path Overhead)
notifying the NUT controller of RPR information
   The NUT controller comprises the following functions:
detecting an STS path carrying RPR packets
determining the update of a NUT table
notifying all nodes constituting the BLSR network of NUT table update information
solving congestion of the NUT table update information
notifying an administrator of the NUT table still being updated

In the following description, functions of the RPR controller and the NUT controller are set forth.

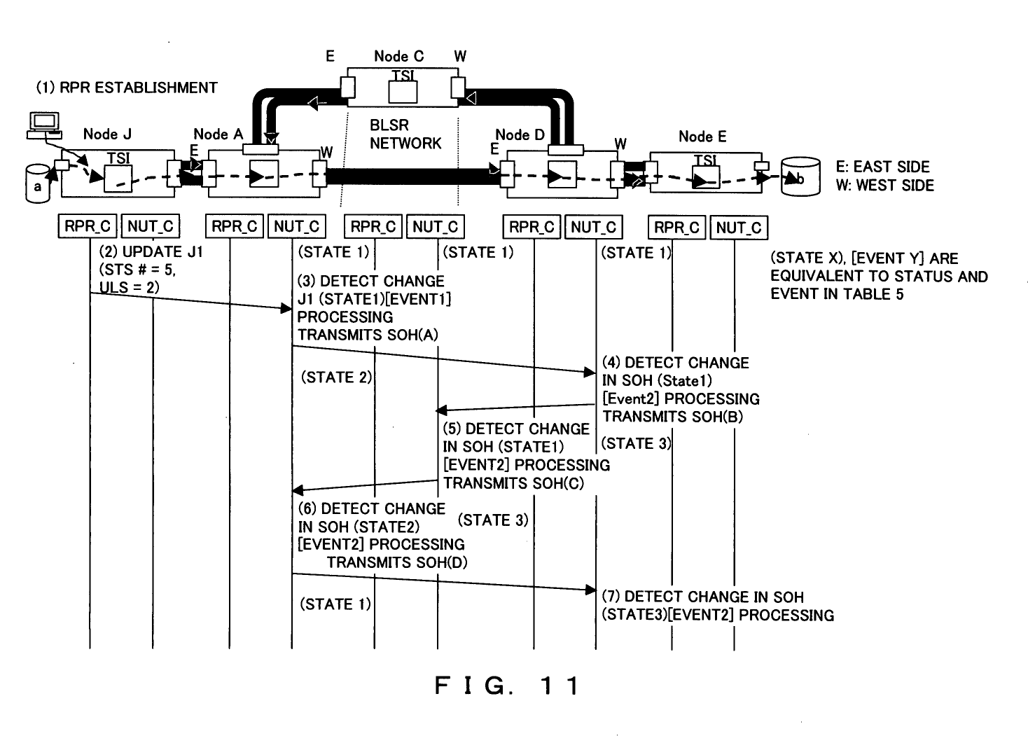

FIG. 11 is an example of a configuration of a network to which the present invention is applied.

In FIG. 11, each of the Node J, Node A, Node D, Node E and Node C is a node, constituting the SONET (or SDH), and among them, the Node A, Node D and Node C constitute a BLSR network. The Node J and the Node E are nodes constituting an RPR network, which is in the high-order layer from the SONET. If a path from the Node J to the Node E were to be established with the capacity of one channel (STS channel #5) of the SONET STS channels, in order to transfer the RPR information indicating that the applicable STS channel #5 is used as an RPR, it would be rational for the RPR network to include the information in its POH. The RPR controller plays a major role in performing this function.

Therefore, in FIG. 11, where the RPR controller is needed are the Node J and the Node E, which also function as RPR nodes.

In the Node A, the Node B and the Node C constituting the BLSR, meanwhile, in order to stabilize the recovery function of the RPR, which is the high-order layer, the setting, which disables the recovery function of the BLSR is set for the applicable path. This can be realized by setting the applicable path to the NUT channel. In other words, update of the NUT table is performed.

After detecting that the path is set as an RPR, the NUT table of each node constituting the BLSR network is updated in accordance with the node, constituting the BLSR network, which the path goes though. Here, the settings of the NUT table are different in each node, and thus an SOH, which is easily referred to by each node, includes information relating to the NUT setting. The NUT controller plays a major role in performing this function.

Therefore, in FIG. 11, where the NUT controller is needed are the Node A, the Node D and the Node C, which also function as BLSR nodes.

In the present embodiment, the J1 byte of the POH is used as means for transmitting the RPR information, and D1, D2 and D3 of the SOH are used as means for transmitting the NUT information.

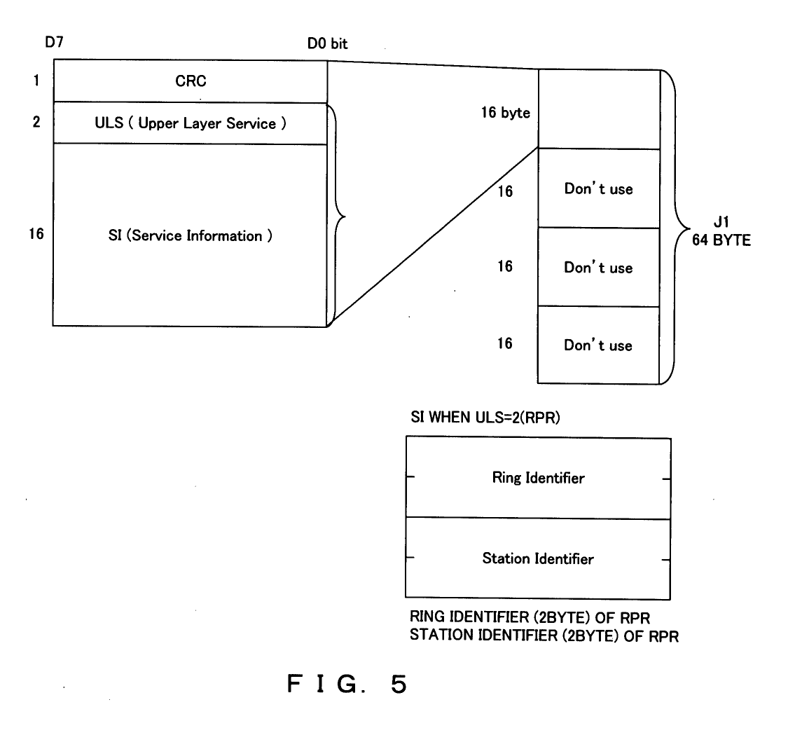

FIG. 5 is an explanatory diagram of the RPR information transmitting means.

The RPR information, which indicates a path setting of the RPR network, uses the J1 byte of the POH of SONET. J1 is 64 bytes and the first 16 bytes of the 64 bytes are used. The first 16 bytes comprise a CRC (Cyclic Redundancy Checksum), ULS (Upper Layer Service) and SI (Service Information) information. The CRC is a calculation result of a CRC 7 of the ULS and SI. The ULS is an identifier indicating types of upper layer protection service provided in a signal of the STS payload, the value “0” indicating no service, the value “1” indicating RSTP and the value “2” indicating RPR. The SI is service information when the ULS is other than “0”. In the present embodiment, when the ULS is “2”, a ring identifier and a station identifier are established in the SI. The ring identifier is 2-byte information, and is a ring identifier of the RPR. The station identifier is also 2-byte information, and is a station identifier of the RPR.

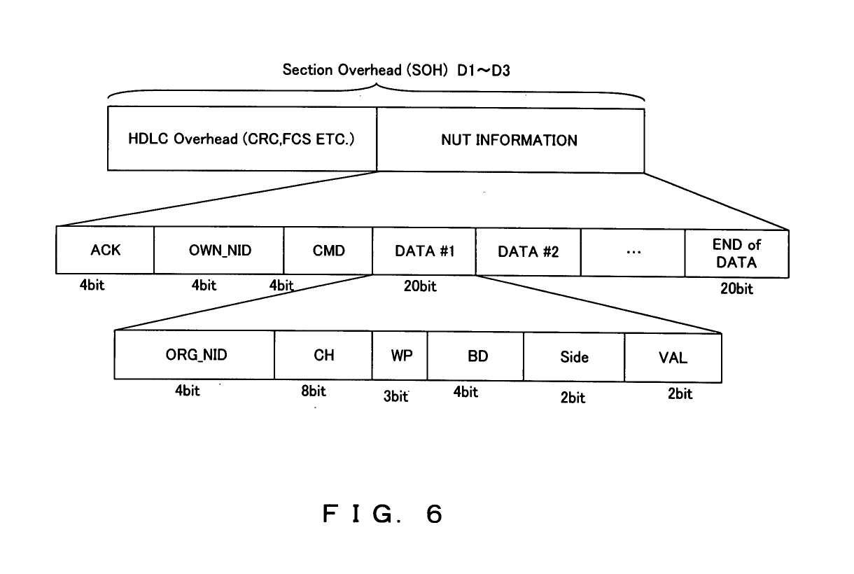

FIG. 6 is a diagram explaining NUT information transmission means.

The D1-D3 bytes are successively used. The D1-D3 bytes comprise an HDLC overhead and the NUT information. The HDLC overhead comprises a CRC and an FCS (Frame Check Sequence) etc. the NUT information comprises an ACK, an OWN_NID, a CMD, DATA and an END of DATA. The ACK is 4 bits, and indicates a response to the NUT update information distribution from the owner, which is the distribution origin node of the NUT information, which came from the other nodes. Zero is the default, and 1-15 is the number of the responding node. Each of the nodes, which received the NUT update information, when transmitting the NUT update information to the adjacent nodes, adds 1 to the value. The OWN_NID comprises 4 bits and is an ID of the NUT update information distribution node. The BLSR is 16 nodes at its maximum, and assumes a value of 0-15. Its default is 0xFF. The CMD comprises 4 bits and is an identifier of NUT information instruction content. The value “0” indicates that nothing is to be done, and the value “1” indicates that the NUT information is to be disseminated. The DATA is the NUT information update information. One segment of DATA takes 20 bits, and comprises ORG_NID, CH, WP, BD, Side, and VAL, comprising 4 bits, 8 bits, 3 bits, 4 bits, 2 bits, and 2 bits, respectively. The ORG_NID is an ID of the NUT update information notification origin node (hereinafter referred to as an originator). It assumes a value from 0 through 15, and the default and the END of DATA are 0xFF. CH is the first number of the NUT update target channel, and has a value from 1 through 192. WP is an identifier indicating the type of the NUT update target channel (i.e. working/protection), and the value “0” indicates working, “1” indicates protection and “2” indicates both of them. BD is information about how many channels in a row are NUT update targets starting from the first channel number, and takes a value from 1 through 192. Side is an identifier indicating a direction, to which the NUT update target channel belongs, the value “0” representing east and the value “1” representing west. VAL is an identifier indicating whether to be the NUT channel or not, the value “0” indicating OFF and the value “1” indicating ON (i.e. considered to be the NUT channel).

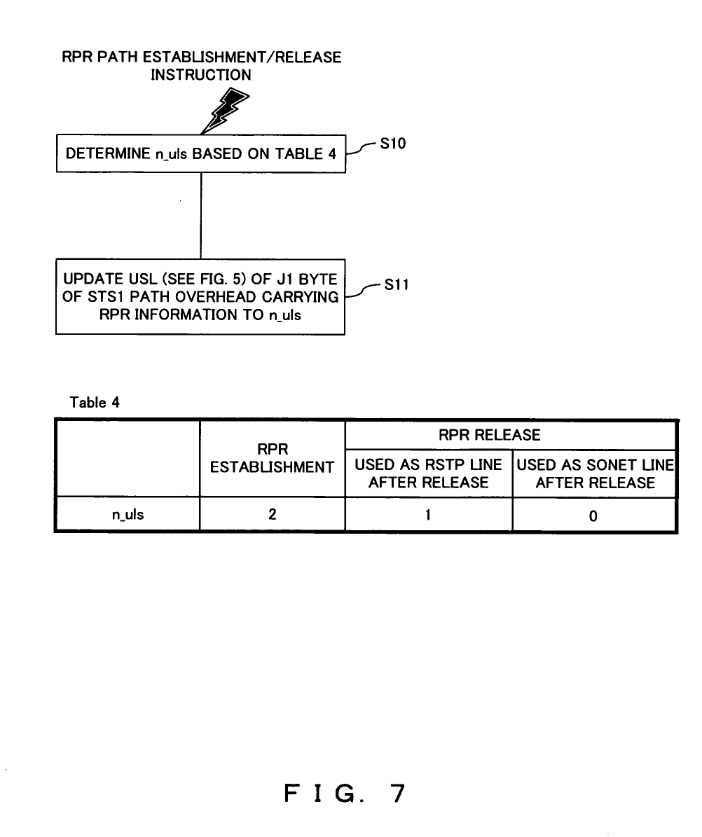

The above information transmission method is used so that a SONET device can update the NUT table setting autonomously and accurately by the autonomous control method shown in FIG. 7-FIG. 10.

The RPR controller updates the J1 byte of the POH of the target STS path according to the definition in FIG. 5, when an RPR path is established/released.

The NUT controller monitors the J1 byte of the POH of the STS path added to the BLSR network, and determines whether it is an RPR carrier path or not, by using the definition of FIG. 5. The NUT controller, when newly detecting an RPR carrier path added to the BLSR, updates the NUT table of the node, in which the NUT controller is comprised, in accordance with the channel number, to which the path belongs, and the Side, to which the path is transferred, in order to set the path to the NUT channel.

The NUT controller, when detecting that the RPR carrier path added to the BLSR is changed to a path carrier other than the RPR, updates the NUT table of the node, in which the NUT controller is comprised, in accordance with the channel number, to which the path belongs, and the Side, to which the path is transferred, in order to release the NUT channel setting of the path.

In the NUT controller, as described above, when detecting a change in the RPR information of the path added to the BLSR, the section overhead in the transmission line addressed to an adjacent station of the BLSR is updated based on the information, using the definition of FIG. 6. The NUT controller monitors the section overhead of the BLSR line, and receives the NUT information using the definition of FIG. 6. The NUT controller, after receiving the NUT information, updates the NUT table of the station, in which the NUT controller is comprised, based on the information, and also updates the ACK area of the transmitted section overhead in the Side, which is not the receiving Side, according to the definition of FIG. 6. The NUT controller, when receiving the NUT information, refers to the OWN_NID of FIG. 6.

When the OWN_NID is equal to the node ID of the node, in which the NUT controller is comprised, and the ACK is equal to the number of nodes in the BLSR, the CMD area of the transmitting SOH of the Side, which is not the receiving Side, is updated to 0, and ACK is updated to 0. That is when the node itself is the owner and the NUT update information, which the node itself requested to be updated, returns after going around the BLSR network, the node itself processes the NUT update information to terminate it.

FIG. 7 is a diagram explaining the operation of the RPR controller of the node, which received an instruction to establish or to release the RPR path.

In the flow of FIG. 7, a variable n_uls is determined based on the instruction of an RPR network administrator, for example, with reference to Table 4 (step S10). In step S11, the ULS (see FIG. 5) of the J1 byte and the STS path overhead carrying the RPR information are updated in n_uls, and is transmitted. Table 4 is a table of setting values of n_uls, n_uls is set to “2” when establishing the RPR, to “1” when the RPR is released and used as the RSTP line after the release, and to “0” when using as a SONET line after the release.

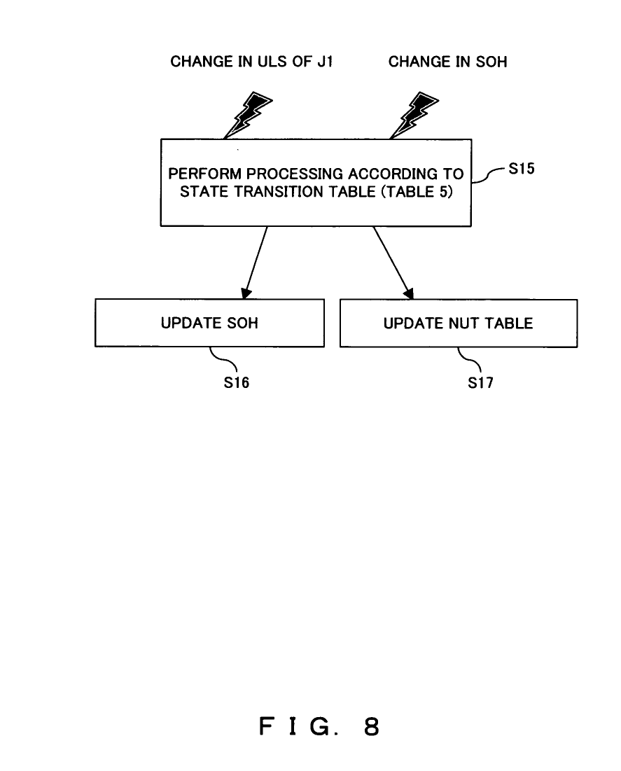

FIG. 8 is a diagram explaining processing of the NUT controller of the SONET device of the node, which received the instruction to establish or to release the RPR path.

When the ULS of the J1 byte changes or the SOH changes as an event, the NUT controller performs processing in step S15 in accordance with the state transition table. The NUT controller updates the SOH in step S16 or updates the NUT table in step S17. When the RPR network is established the J1 byte changes. When detecting this change, the NUT controller updates the NUT table of a device, in which the NUT controller is comprised, and additionally, sets the SOH of the NUT table that the device updated, and transmits the information.

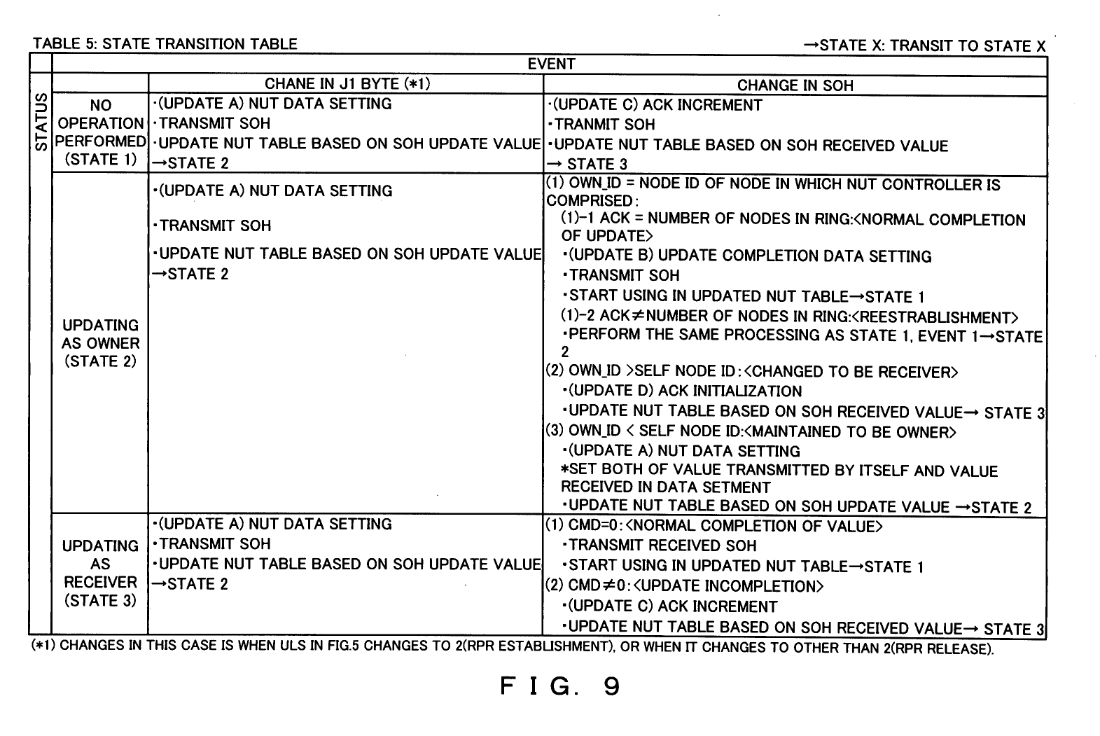

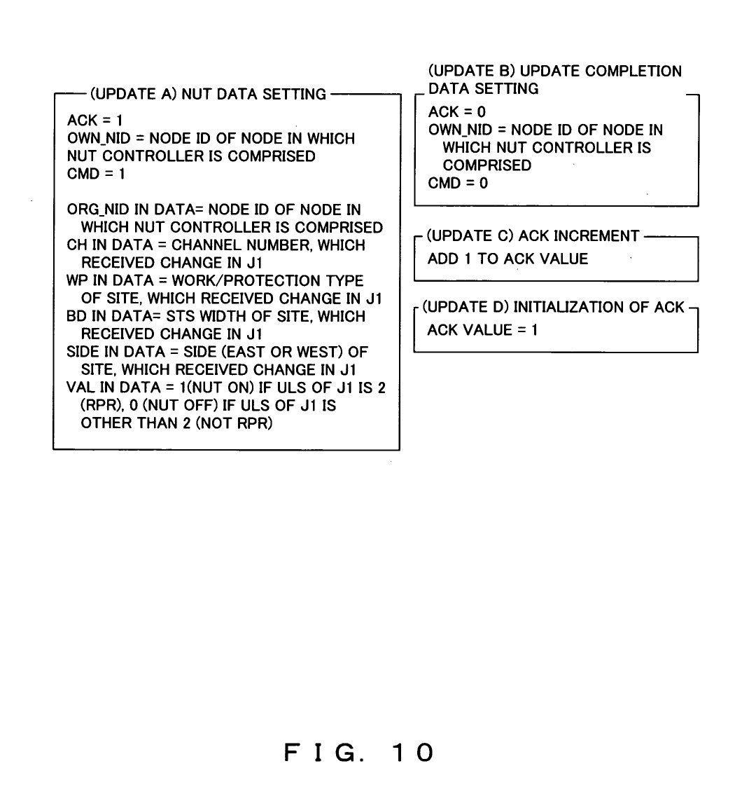

FIG. 9 and FIG. 10 are state transition tables showing the operation of the NUT controller.

When the NUT controller does not perform any operation (State 1), if the J1 byte changes the NUT controller sets NUT data as update A. The SOH is transmitted, the NUT table is updated based on the SOH update value, and processing proceeds to State 2. When the SOH changes in State 1, as update C, ACK increment is performed, the SOH is transmitted, the NUT table is updated based on the SOH reception value and processing proceeds to State 3.

During the update of the information as an owner (State 2), when the J1 byte changes, NUT data setting of the update A is performed, the SOH is transmitted, the NUT table is updated based on the SOH update value, and State 2 is maintained. If the SOH changes in State 2, when the OWN_ID is a node ID of the node in which the NUT controller is comprised, and when the ACK is the number of nodes in the ring, as the normal update termination, update completion data setting of update B is performed, the SOH is transmitted, the operation is started with the updated NUT table, and the status changes to State 1. When the ACK is not consistent with the number of node in the ring, State 2 is maintained. When the OWN ID is larger than the above node ID, in order to change the device, in which the NUT controller is comprised, to a receiver, as update D, initialization of the ACK is performed, the NUT table is updated based on the SOH reception value, and the status changes to State 3.

When the OWN_ID is smaller than the above node ID, in order to maintain an owner, the NUT data setting, which is update A, is performed. At this point, both the value that the NUT controller transmitted, and the received value are set to the DATA unit of the NUT information. The NUT table is updated based on the SOH update value, and the State 2 is maintained.

When the J1 byte changes during the update as a receiver (State 3), as update A, the NUT data is set, the SOH is transmitted, the NUT table is updated based on the SOH update value and the status changes to State 2. When the SOH changes, if the CMD is 0 indicating normal completion of the update, the reception SOH is transmitted, the operation is started with the updated NUT table, and the status proceeds to State 1. If the CMD is not 0 indicating an incomplete update, the ACK increment is performed as update C, the NUT table is updated based on the SOH reception value and State 3 is maintained.

In the above case, the change in the J1 byte refers to when the ULS changes to 2 or changes to a value other than 2.

FIG. 10 is a diagram showing detailed content of the updates A-D.

In the NUT data setting of update A, the ACK is set to 1, the OWN_NID is set to the node ID of the node, in which the NUT controller is comprised, and the CMD is set to 1. In addition, the ORG_NID of the DATA is set to the above node ID, the CH of the DATA is set to the number for the channel, which received the change in the J1, the WP of the DATA is set to the working/protection type of the site where the change in J1 is received, the BD of the DATA is set to the STS width of the site where the change in J1 is received, the Side of the DATA is set to the Side (east or west) of the site, where the change in J1 is received, and the VAL of the DATA is set to 1 when the ULS of J1 is 2 and to 0 when it is other than 2.

In the update completion data setting of update B, the ACK is set to 0, the OWN NID is set to a node ID of the node in which the NUT controller is comprised, and the CMD is set to 0. In the ACK increment of update C, the ACK value is incremented by 1. In the ACK initialization of update D, the ACK value is set to 1.

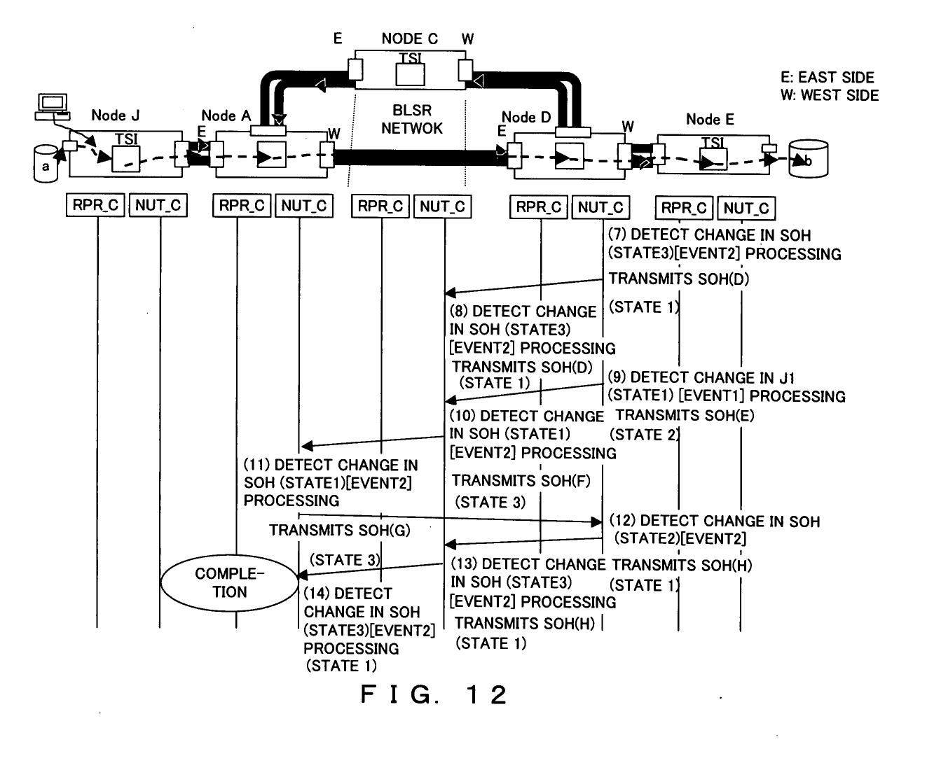

FIG. 11 and FIG. 12 are processing sequences when the NUT table is established for each device. Here, as described in each figure, the case that the RPR network is established with the Node J, the Node A, the Node D and the Node E, and the BLSR network is established with the Node A, the Node C, and the Node D is shown.

First, when the instruction of the RPR establishment is issued (1), the NUT controller of the Node A sets STS#=5, and ULS=2, and the J1 byte is updated (2). Next, the NUT controller of the Node A detects the change in the J1 byte, performs the (State 1) [Event 1] processing of FIG. 9, and transmits the SOH (A) (3). In order to explain the content of the SOH later, a distinction is made by assigning labels (A) etc. The Node A changes from State 1 to State 2. The SOH (A) is received by the NUT controller of the Node D, and when detecting the change in the SOH, the Node D performs (State 1) [Event 2] processing and transmits the SOH (B) (4). The state of the Node D changes from State 1 to State 3. When the NUT controller of the Node C detects the change in the SOH, (State 1) [Event 2] processing is performed, and the SOH (C) is transmitted (5). The state of the Node C changes from State 1 to State 3. When the NUT controller of the Node A detects the change in the SOH, (State 2) [Event 2] processing is performed. Then, the SOH (D) is transmitted (6). And the state of the Node A changes from State 2 to State 1. When the NUT controller of the Node D detects the change in the SOH, (State 3) [Event 2] processing is performed and the SOH (D) is transmitted (7). At that time, the state of the Node D changes from State 3 to State 1. When the NUT controller of the Node C detects the change in the SOH, (State 3) [Event 2] processing is performed, the SOH (D) is transmitted, and the state changes from State 3 to State 1 (8). When the NUT controller of the Node D detects the change in the J1, (State 1) [Event 1] processing is performed, the SOH (E) is transmitted, and the state changes from State 1 to State 2 (9). When the NUT controller of the Node C detects the change in the SOH, (State 1) [Event 2] processing is performed and the SOH (F) is transmitted, changing State 1 to State 3 (10). When the NUT controller of the Node A detects the change in the SOH, (State 1) [Event 2] processing is performed, the SOH (G) is transmitted, and the state changes from State 1 to State 3 (11). When the NUT controller of the Node D detects the change in the SOH, (State 2) [Event 2] processing is performed, the SOH (H) is transmitted, and the state changes from State 2 to State 1 (12). When the NUT controller of the Node C detects the change in the SOH, (State 3) [Event 2] processing is performed and the SOH (H) is transmitted, changing State 3 to State 1 (13). When the NUT controller of the Node A detects the change in the SOH, (State 3) [Event 2] processing is performed, the state changes from State 3 to State 1, and the processing is terminated (14).

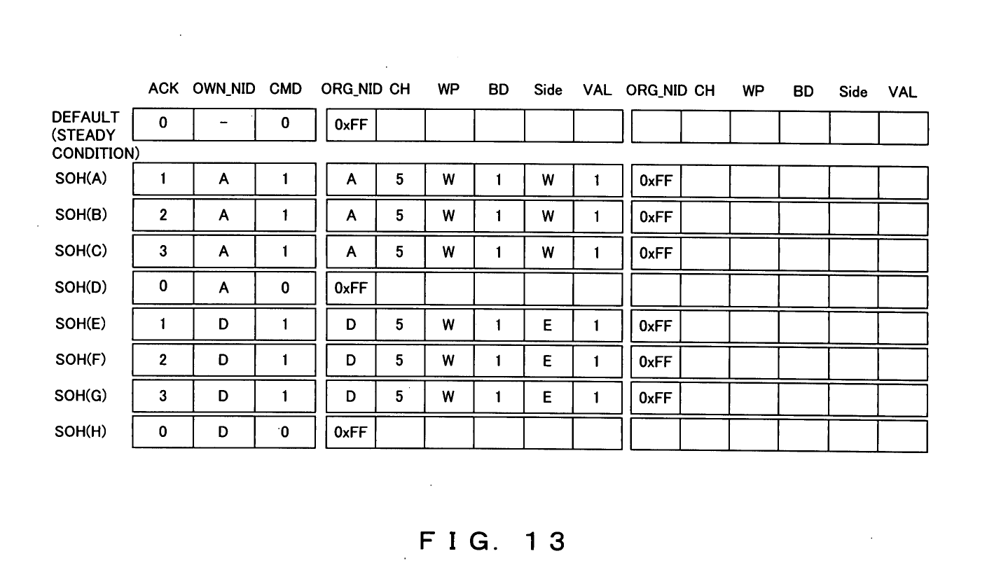

In the explanation above, the (State 1) [Event 1] processing indicates the processing when “the J1 byte changes” in the state that “(the NUT controller) does not perform any processing” in FIG. 9. The same applies to the other processes. FIG. 13 is a diagram showing an example of a value of the SOH in the processing in FIG. 11 and FIG. 12.

Nothing is set in the SOH by default. The SOH (A) is provided with A as the OWN_NID. The Node A is set as the ORG_NID for origin of the SOH. The CMD, which is the value indicating that the NUT update information is being disseminated, is set to 1. The channel, which is set to the NUT setting, is set to channel 5, and the NUT setting target channel is set so that it is the working line, and is set to channel 5 alone and is set to west side only. To understand the meaning of the SOH, the explanation in FIG. 6 should be referred to. The SOH is referred to by all nodes when it becomes the SOH (C), and therefore, the content of the SOH is cleared in the SOH (D). Next, the distribution destination of the SOH becomes D at the SOH (E). The SOH (E), the SOH (F), and the SOH (G) notifies the NUT setting in the east direction in the channel 5, and after the notification, the content of the SOH is cleared in the SOH (H).

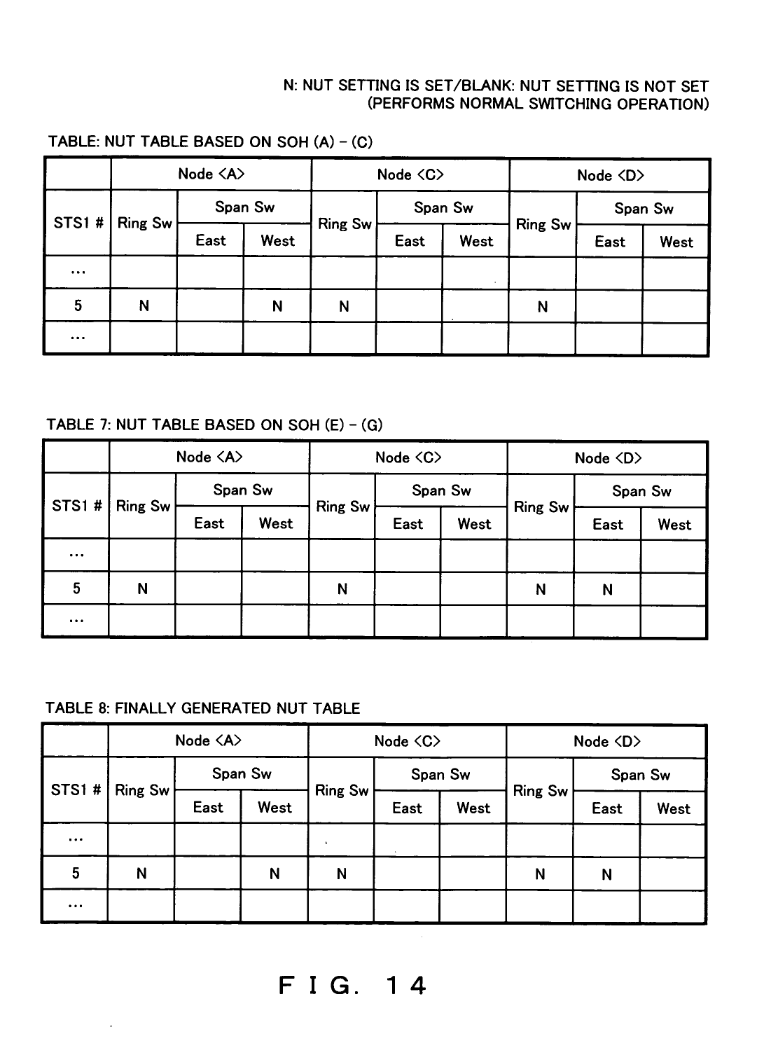

FIG. 14 is a diagram indicating the update value of the NUT table set by the operation of FIG. 11-FIG. 12. In these tables, N represents the NUT setting, and a blank represents that the NUT setting is not set.

Table 6 shows the update status of the NUT table based on the SOH (A)-(C). The ring switch is set as the NUT setting for the Node A, the Node C and the Node D, and additionally, the west side of the span switch is set as the NUT setting at the Node A. Table 7 is the update value of the NUT table based on the SOH (E)-(G), the ring switch is set as the NUT setting for the Node A, the Node C and the Node D, and the east side of the span switch is set as the NUT setting at the Node D.

Table 8 is the NUT table generated finally, in which the ring switch of the Node A, the Node C and the Node D are set as the NUT setting, and the west side of the span switch of the Node A and the east side of the span switch of the Node D are set as the NUT setting.

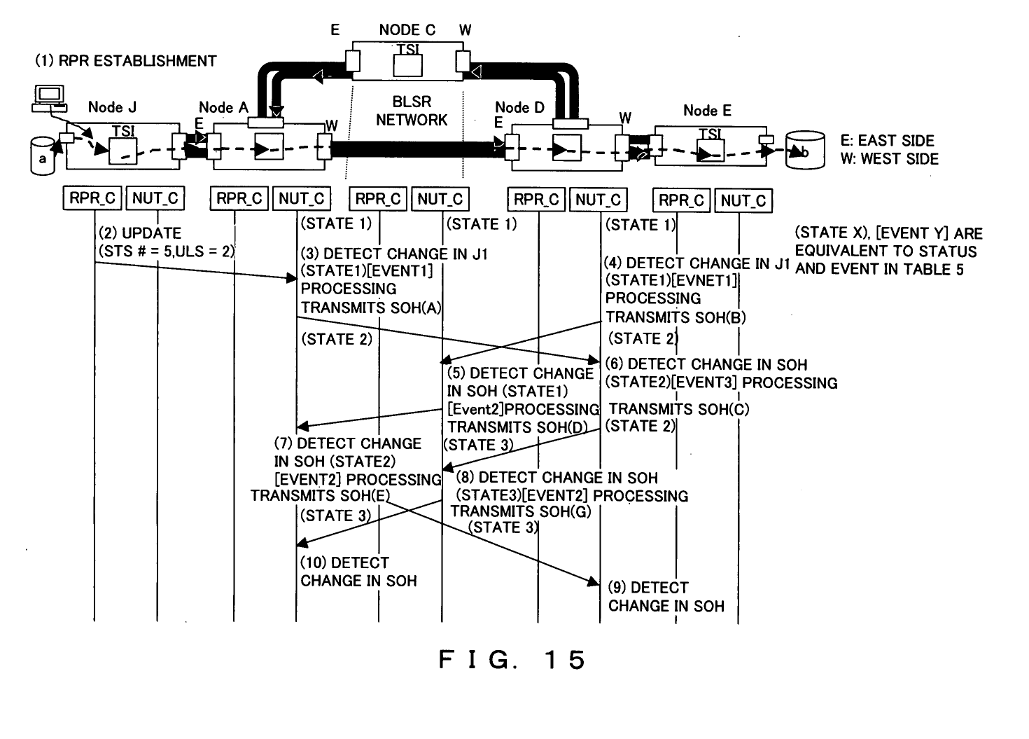

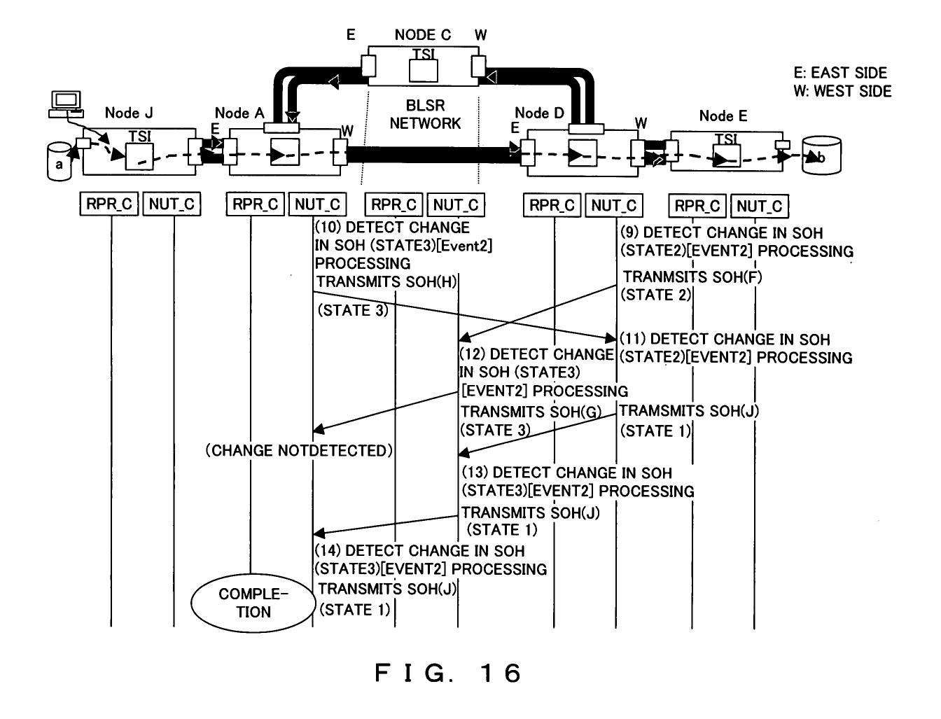

All of the NUT setting is on the channel 5. FIG. 15 and FIG. 16 are processing sequences where the NUT tables are established in two sites in parallel.

When the RPR establishment is initiated from the Node J (1), the RPR controller of the Node J updates the J1 byte (2). Here, it is STS#=5 (the channel 5), and ULS=2. When the NUT controller of the Node A detects the change in the J1 byte, (State 1) [Event 1] processing is performed, the SOH (A) is transmitted, and the state changes from State 1 to State 2 (3). Meanwhile, when the NUT controller of the Node D detects the change in the J1 byte, (State 1) [Event 1] processing is performed, the SOH (B) is transmitted, and the state changes from State 1 to State 2 (4). When the NUT controller of the Node D detects the change in the SOH transmitted from the NUT controller of the Node A, (State 2) [Event 3] processing is performed, and the SOH (C) is transmitted (6). On the other hand, the NUT controller of the Node C detects the change in the SOH transmitted from the NUT controller of the Node D, (State 1) [Event 2] processing is performed, the SOH (D) is transmitted, and the state changes from State 1 to State 3 (5). When the NUT controller of the Node A detects the change in the SOH transmitted from the NUT controller of the Node C, (State 2) [Event 2] processing is performed, the SOH (E) is transmitted, and the state changes from State 2 to State 3 (7).

When the NUT controller of the Node C detects the change in the SOH transmitted from the NUT controller of the Node D, (State 3) [Event 2] processing is performed, and the SOH (G) is transmitted (8).

When the NUT controller of the Node D detects the change in the SOH transmitted from the NUT controller of the Node A, (State 2) [Event 2] processing is performed, and the SOH (F) is transmitted (9). When the NUT controller of the Node C detects the change in the SOH transmitted from the NUT controller of the Node D, (State 3) [Event 2] processing is performed, and the SOH (G) is transmitted (12). The Node A does not detect the change in the SOH transmitted from the NUT controller of the Node C.

When the NUT controller of the Node A detects the change in the SOH transmitted from the NUT controller of the Node C, (State 3) [Event 2] processing is performed, and the SOH (H) is transmitted (10). When the NUT controller of the Node D detects the change in the SOH transmitted from the NUT controller of the Node A, (State 1) [Event 2] processing is performed, the SOH (J) is transmitted, and the state changes from State 2 to State 1 (11). When the NUT controller of the Node C detects the change in the SOH transmitted from the NUT controller of the Node D, (State 3) [Event 2] processing is performed, the SOH (J) is transmitted, and the state changes from State 3 to State 1 (13). When the NUT controller of the Node A detects the change in the SOH transmitted from the NUT controller of the Node C, (State 3) [Event 2] processing is performed, the SOH (J) is transmitted, the state returns from State 3 to State 1, and the processing is completed (14).

In the above sequence, the eastbound SOH and the westbound SOH are mixed.

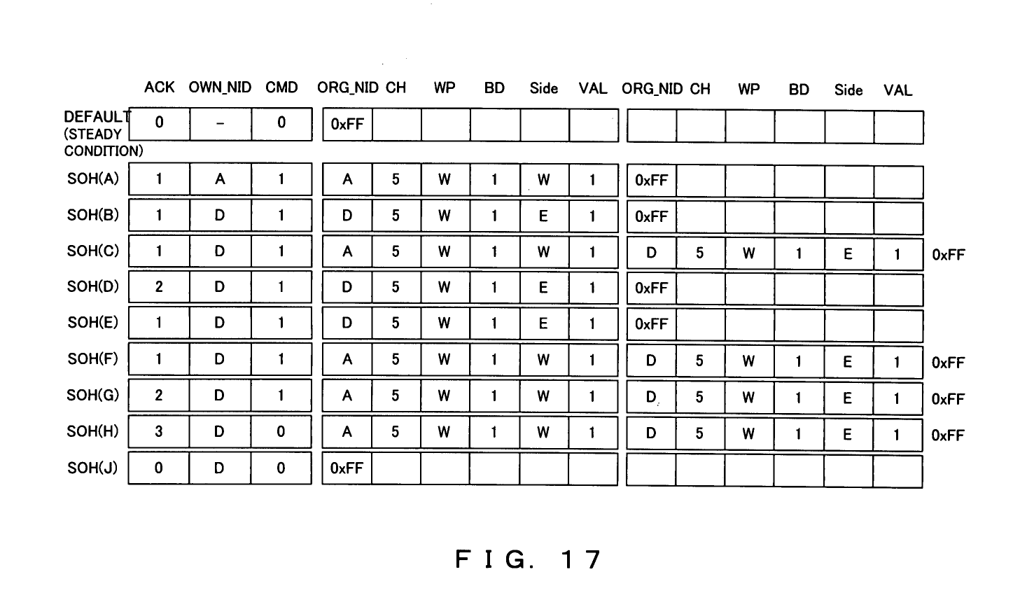

FIG. 17 is a diagram showing an example of the values of the SOH, which appear in the sequence in FIG. 15 and FIG. 16. In the SOH (A), the Node A, being the origin, requests setting of the NUT setting in the westward direction of the work line of the channel 5. In the SOH (B), the Node D, being the origin, requests setting of the NUT setting in the eastward direction of the work line of the channel 5. To understand the SOH, the explanation in FIG. 6 should be referred to.

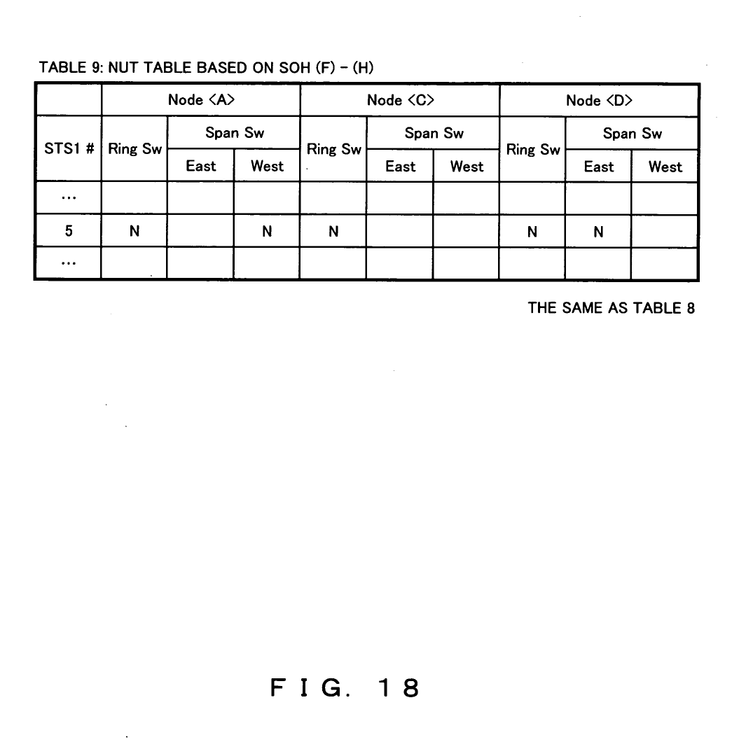

FIG. 18 is a diagram showing the NUT table update value, in the cases of FIG. 15-FIG. 17.

Table 9 is the NUT table, based on the SOH (F)—the SOH (H). The ring switch is set as the NUT setting for the Node A, the Node C and the Node D, and the west side of the span switch of the Node A and the east side of the span switch of the Node S are set as the NUT setting.

In the above embodiment, the RPR controller and the NUT controller are established separately in the explanation; however, both controllers may be provided on a SONET device, or a configuration, providing the RPR controller alone in a router part of both ends of the RPR network, and the NUT controller alone in the SONET device at the gateway to the path of the part, which the RPR network uses as the SONET ring, is also possible.

What is claimed is:

1. A node in a ring topology synchronous digital network in which a plurality of nodes are connected in a ring topology and, in a case of failure, a function for recovering in units of paths is comprised, the node comprising:
a control unit for detecting upper layer network usage information in a path added to the synchronous digital network ring from other than the synchronous digital network, and for transferring disable request information of a recovery function in units of paths in the synchronous digital network ring to each node constituting the synchronous digital network ring when the upper layer network usage information indicates a failure recovery target path in the upper layer.

2. A NUT table automatic update system in establishing an RPR network using a part of paths in a SONET/SDH ring, comprising:
RPR control means for transmitting RPR information that the RPR network is set in a network device comprised in the RPR network in response to reception of an instruction of a setting of the RPR network; and
NUT control means for, by receiving the RPR information, automatically transmitting NUT information that a NUT table, which applies to the RPR network setting, should be updated at another network device, which belongs to a SONET/SDH ring, to which the network device belongs.

3. The NUT table automatic update system according to claim 2, wherein the RPR information is transmitted using a J1 byte of a path overhead in a frame of a SONET/SDH.

4. The NUT table automatic update system according to claim 2, wherein the RPR information is transmitted using a J1 byte of a section overhead in a SONET/SDH frame.

5. The NUT table automatic update system according to claim 2, wherein the NUT information is set to prohibit the use of a span switch of a span belonging to the RPR network and the use of a ring switch for a channel used for the RPR network in a network device at the border of the RPR network and the SONET/SDH ring.

6. A network device, which belongs to any network in establishing an RPR network using a part of a path in a SONET/SDH ring, comprising:
RPR control means for transmitting RPR information that the RPR network is set in a network device comprised in the RPR network in response to reception of an instruction of a setting of the RPR network; and
NUT control means for, by receiving the RPR information, automatically transmitting NUT information that a NUT table, which applies to the RPR network setting, should be updated at another network device, which belongs to a SONET/SDH ring, to which the network device belongs.

7. The network device according to claim 6, wherein the RPR information is transmitted using a J1 byte of a path overhead in a frame of a SONET/SDH.

8. The network device according to claim 6, wherein the RPR information is transmitted using a J1 byte of a section overhead in a frame of a SONET/SDH.

9. The network device according to claim 6, wherein the NUT information is set to prohibit the use of a span switch of a span belonging to the RPR network and the use of a ring switch for a channel used for the RPR network to a network device at the border of the RPR network and the SONET/SDH ring.

10. A NUT table automatic update method in establishing an RPR network using a part of paths in a SONET/SDH ring, comprising:
transmitting RPR information that the RPR network is set in a network device comprised in the RPR network in response to reception of an instruction of a setting of the RPR network; and
automatically transmitting NUT information that a NUT table, which applies to the RPR network setting, should be updated to another network device, which belongs to a SONET/SDH ring, to which the network device belongs by receiving the RPR information.
